(19) United States
(12) Patent Application Publication
(10) Pub. No.: US 2009/0061697 A1
(43) Pub. Date: Mar. 5, 2009

(54) Kwik attach plug and wiring harness

(76) Inventor: Keith Thomas Burton, Honea Path, SC (US)

Correspondence Address: Keith Thomas Burton, 209 Canfield Road, Honea Path, SC, 29654, US

(21) Appl. No.: 11/714,428

(22) Filed: Aug. 27, 2007

(51) Int. Cl. H01R 4/28

(52) U.S. Cl. 439/754

(57) ABSTRACT

The Kwik-Attach plug is designed to make the connection of different accessories more convenient for the user of the equipment. This wiring harness can be attached to any all-terrain vehicle, utility vehicle, truck, car, boat, lawn mower, or any 12 volt battery system. The user can operate lights, air pumps, landscape sprayers, spreaders, or any other attachment that requires power for operation. This plug can be mounted anywhere on the vehicle and replaces the power plug or battery clips on the attachment.

The Kwik Attach Accessory Harness is made of two 10 gauge wires, one red and one black in color to enable any person to be able to connect this harness to their vehicle with a 12 volt battery.

The purpose of this harness is to make it safer and easier to operate any tool that you may need. To install the harness you must first mount it to your vehicle where desired, then run the wires to the battery and connect the color coded wires to the battery, remember the red wire goes to the red or positive pole (+) of the battery and the black wire goes to the black pole or negative (−) side of the battery. Once you have connected the wires and mounted the plug it is ready for use. On your equipment you also have the same coded wires, the female end has a positive end (red) and a negative end (black). To install the female end you must crimp each wire to the conductors red to positive (+) and black to negative (−) and you are ready to use your equipment with ease.

### BRIEF DESCRIPTION OF THE DRAWINGS

Non-limiting and non-exhaustive embodiments of the present invention are described in the Figures, in which:

FIG. 1 is a perspective view of the terminal housing of the Kwik Attach plug

FIG. 2 is a perspective view of the conductors of the Kwik Attach plug.

FIG. 3 is a perspective view of the primary wires of the Kwik Attach plug.

FIG. 4 is a perspective view of the ring terminal ¼″ stud of the Kwik Attach plug.

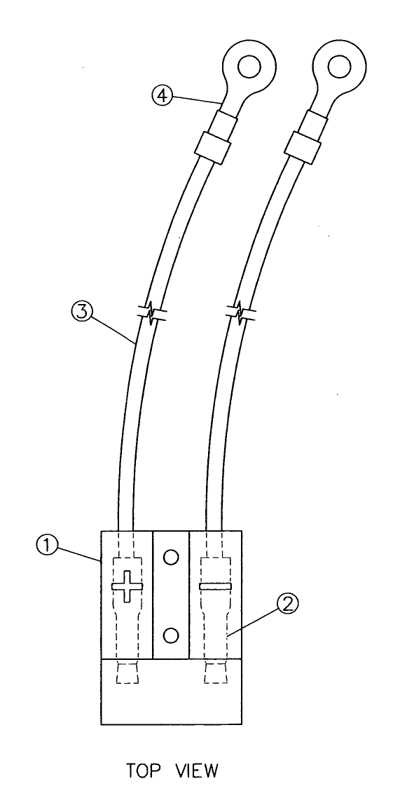

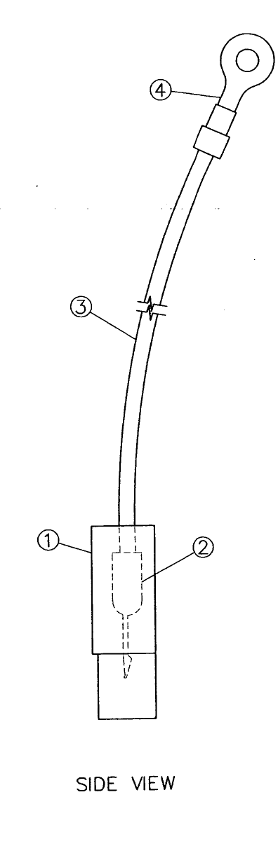

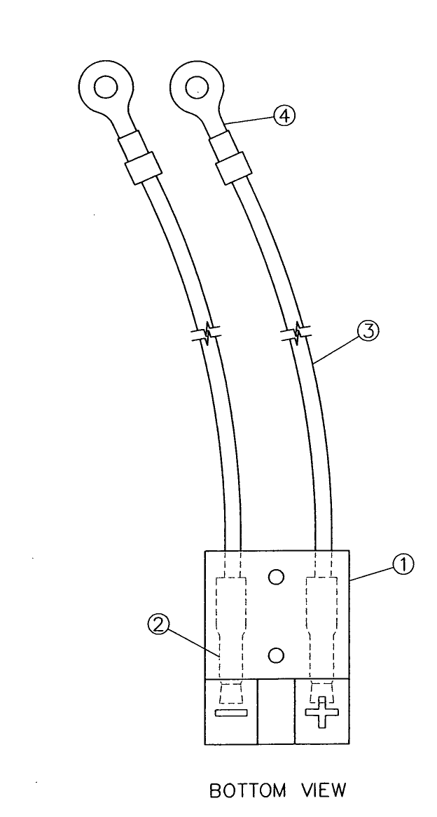

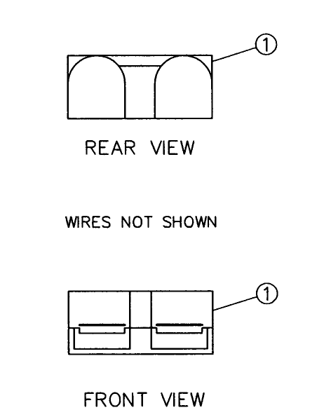

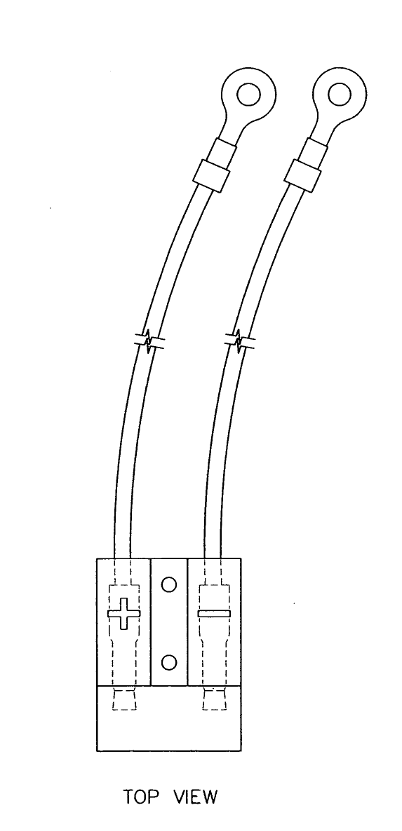

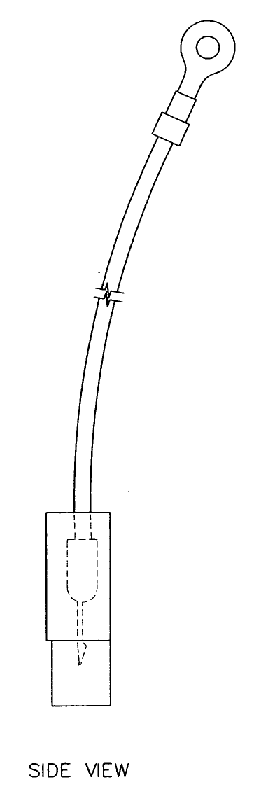

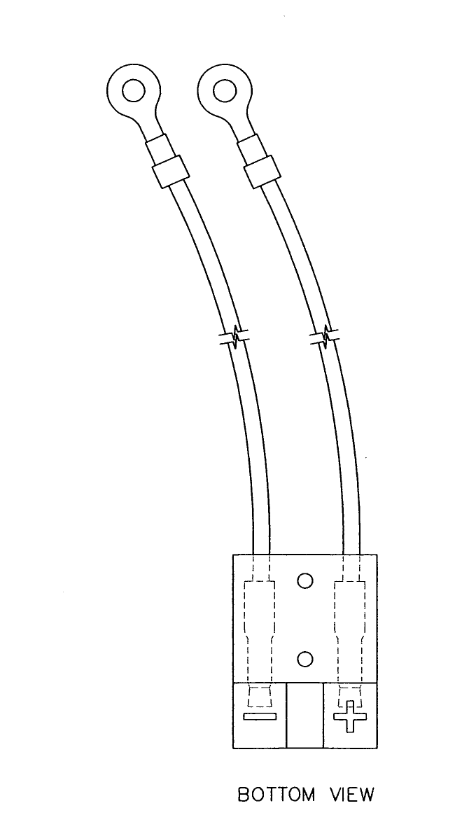

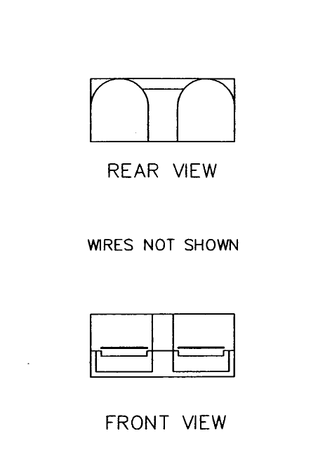

1. Kwik Attach Accessory Harness is designed to make it safer and easier to use any 12 volt tools needed in the work force or at play. The harness used on an ATV will keep the customer from having to take the seat off the ATV to hook the equipment up the he or she desires to use. By doing this it will save time and any chance of injury from hooking up clamps to the battery, with the injury question in mind many pieces of equipment have clamps that you have to open and place on the battery, many people don't know that if you hook these clamps up to the wrong places this may cause the battery to explode causing painful injuries to the operators. This is the reason for this new harness to make it safer and easier for the public.
